(19) United States
(12) Patent Application Publication
(10) Pub. No.: US 2019/0076679 A1
(43) Pub. Date: Mar. 14, 2019

(54) PORTABLE FALL PROTECTION DEVICE

(71) Applicant: CHECKMATE LIFTING & SAFETY LTD, Kent (GB)

(72) Inventors: Oliver AUSTON, Kent (GB); William Michael Gorden NEWING, Kent (GB)

(73) Assignee: CHECKMATE LIFTING & SAFETY LTD, Kent (GB)

(21) Appl. No.: 15/769,262

(22) PCT Filed: Oct. 21, 2016
(86) PCT No.: PCT/GB2016/053298

§ 371 Date: Apr. 18, 2018

(30) Foreign Application Priority Data
Oct. 23, 2015 (GB) 1518793.3

(51) Int. Cl. A62B 1/08; A62B 35/00; A62B 35/04

(52) U.S. Cl. CPC A62B 1/08; A62B 35/04; A62B 35/0093; A62B 35/0025

(57) ABSTRACT

The portable fall protection device essentially comprises a force reduction device that gradually absorbs a tensile force created within a safety line as a user falls from a height. One aim of the portable fall protection device is to gradually arrest the descent of the user falling in a gradual controlled manner to prevent injury to the user. Furthermore, the portable fall protection device is compact such that it can be constantly worn and carried on the back of the user without impinging on the tasks of the user. As a result of the structure of the portable fall protection device, each portable fall protection device can be individually tested prior to use and can be re-used (and/or reset), if necessary after a fall. In addition, the capacity of the portable fall protection device is adjustable and can be set by a manufacturer and/or operator to produce a bespoke device.

### FIELD OF THE INVENTION

The present invention relates to a portable fall protection device, an assembly comprising a harness and a portable fall protection device and a method of reducing a force of a fall. In particular, the present invention relates to a portable fall protection device for reducing the force associated with a fall, a garment including a portable fall protection device for reducing the force associated with a fall and a method of braking and arresting a person falling. More specifically, the present invention relates to a portable fall arrest device and/or a portable fall restraint device.

### BACKGROUND TO THE INVENTION

When working at heights, a person is generally attached to a safety line or rope in order to provide a safety mechanism to restrict a fall. The safety line is fixed at one end to an anchor point and at the other end to the person. Such safety mechanisms generally also incorporate a device for gradually arresting the fall rather than to rely on a simple rope or line which would prevent any fall with a sharp sudden halt. A sharp halt of a fall would produce excessive forces which in themselves may also cause or increase any potential injuries to the user.

These safety mechanisms may be attached to a harness or garment being worn by the user. In particular, the safety line is attached to an anchor point and the other end of the safety line is attached to a simple portable safety mechanism device which is the attached to a person through a harness/garment. Alternatively, a robust static safety mechanism including a braking system may be provided adjacent to the anchor point.

Prior art safety mechanisms include sections of webbing or bungee to provide a gradual absorption and distribution of the falling forces. For example, the safety device may include a section of webbing with a stitching system whereby the stitching is arranged to tear as the person falls whilst the webbing still remains connected to a part of the harness to eventually stop the fall at an end of the stitching section. This tearing of the stitching system gradually reduces the falling forces. The length of the stitching section defines the force absorbing distance and the system of the stitching can be adjusted for use in absorbing different levels of forces.

In an alternative prior art system, a lanyard incorporating a length of bungee (stretchable material) is used. Again, if a person falls the material will stretch and the falling forces will be absorbed and distributed over a distance as the material stretches.

As can be seen from the above, these prior art portable fall arrest devices are single use only such that after a fall has been arrested the device cannot be reused. In addition, even if a relatively minor fall is arrested, the device should not be reused since the device cannot be guaranteed to operate as originally intended.

Furthermore, since these devices cannot be reused, these devices generally need to be tested to destruction to check the force reduction capability. For example, a manufacturer must select a proportion of devices for testing in this manner and the remaining devices in the batch are then assumed to have the same capability/capacity. The manufacturer may select one device in one thousand to test which inevitably means that the vast majority of safety devices are never individually tested. Specifically, in the single use systems, an actual safety device will have never been tested prior to use. The validity of the tests relies on the assumption that all devices within a batch will operate in the same manner with the same capacity. If the selected device fails the test then the remaining devices in the specific batch may also need to be destroyed or recalled. Accordingly, these devices can be wasteful and/or dangerous due to the lack of individual testing.

In the present description, the term fall protection device is defined to include both fall restraint device and fall arrest device.

It is an aim of the present invention to overcome at least one problem associated with the prior art, whether referred to herein or otherwise.

### SUMMARY OF THE INVENTION

According to a first aspect of the present invention there is provided a portable fall protection device comprising:
harness attachment means to attach the portable fall protection device to a harness and for the portable fall protection device to be carried by a user;
a braking member;
an actuating member;
a rotatable hub; and
a spoolable member wound around the hub,
   wherein the hub comprises an engagement surface which is frictionally engaged with a braking surface of the braking member and wherein rotation of the hub is restrained by the friction between the engagement surface and the braking surface and, prior to use, the engagement surface is arranged to be moved relative to the braking surface by the actuating member to adjust the frictional engagement.

The actuating member may be arranged to move the engagement surface relatively towards the braking surface to increase the frictional engagement therebetween. The actuating member may be arranged to move the engagement surface relatively away the braking surface to decrease the frictional engagement therebetween.

Preferably the braking member provides a first braking surface and a second braking surface. Preferably the first braking surface is provided on a first side of the braking member and the second braking surface is provided on a second side of the braking member.

Preferably the braking member comprises a planar member wherein the first braking surface is provided on a first face and the second braking surface is provided on a second face.

Preferably the braking member comprises a static (fixed) braking surface(s).

Preferably the hub comprises a first engagement surface and a second engagement surface.

Preferably the hub comprises a central shaft, a first engagement member and a second engagement member. Preferably the central shaft, the first engagement member and the second engagement member are retained together in order to rotate as a single hub component.

Preferably the braking member is arranged to locate between the first engagement surface (engagement member) and the second engagement surface (engagement member).

Preferably the first engagement surface is provided on a first engagement member and the second engagement surface is provide on a second engagement member.

Preferably the first engagement member is movable towards or away from the second engagement member in order to reduce or increase an engagement gap therebetween. Preferably the braking member locates within the engagement gap.

Preferably the braking member provides a rim with a first braking surface and a second braking surface. Preferably the braking member comprises a planar member.

Preferably the braking member provides a first braking surface of a first side and a second braking surface on a second side.

Preferably the actuating member is manually operable. Preferably the actuating member comprises a threaded nut which is engaged on a threaded surface of the central shaft of the hub. Preferably the threaded nut is movable along the threaded surface of the central shaft.

Preferably movement of the engagement surface(s) relative to the braking surface(s) is arranged to increase or decrease the braking capability of the portable fall protection device. Preferably translational movement of the braking surface(s) relatively towards or away from the engagement surface(s) is arranged to increase or decrease the braking capability of the portable fall protection device.

Preferably a user actuates the actuating member in order to set the predetermined braking capability of the portable fall protection device.

The actuating member may comprise a threaded nut which is arranged to move the engagement surface(s) translationally towards or away from the braking surface(s).

The actuating member may comprise a locking device in order to lock the position of the actuating member in a predetermined set position. The locking device may be releasable to enable the actuating member to be operable and the locking device is then locked to prevent further subsequent movement of the actuating member.

The portable fall protection device may comprise a housing. Preferably the housing comprises a slot in order for the spoolable member to extend therethrough.

Preferably the hub is rotatably mounted within the housing.

Preferably the hub comprises a drive shaft. Preferably the drive shaft rotatably mounts the hub within the housing.

Preferably the spoolable member is arranged to be wound around the hub. Preferably an inner end of the spoolable member is secured to the hub (and preferably to an inner axial portion of the hub). The spoolable member may project through an opening in the housing to provide an outer end with a connecting member secured thereto.

Preferably the spoolable member comprises a section of webbing. Preferably the section of webbing comprises a connecting member which may enable the section of webbing to be attached/detached from (or connected/disconnected to) a safety line. The connecting member may be arranged to be directly attached to a connecting element provided on a safety line. Preferably the connecting element comprises a carabiner fixed to an end of the safety line.

The weight of the portable fall protection device may be less than 1 kilogram. Preferably the weight of the portable fall protection device is less than 700 grams and more preferably is less than 550 grams.

Preferably the portable fall protection device is used within a predetermined weight range such that the fall arrest device is able to safely arrest the fall of that weight.

The upper limit of this predetermined weight range may be 200 kilograms and preferably is 150 kilograms and more preferably is 140 kilograms.

The lower limit of this predetermined weight range may be 40 kilograms and preferably is 50 kilograms and more preferably is 60 kilograms.

Preferably this predetermined weight range is substantially 60 kilograms to 136 kilograms.

Preferably the fall arrest device comprises a rotation driven brake which may be manually adjustable. The manual adjustment may be made in accordance with any maximum input load and/or weight of the user.

Preferably the portable fall protection device can be torqued to a range of settings to accommodate different force outputs and different weights of users.

Preferably the fall arrest device may be arranged to hold a static force of approximately 50% of the arresting force.

Preferably the connecting member is replaceable with a connecting member of a different configuration.

The connecting member may locate at or towards a longitudinal end of the spoolable member. The spoolable member may be connected to a single safety line/connecting leg. The spoolable member may be connected to two (separate) safety lines/connecting legs.

Preferably the portable fall arresting device comprises connecting legs the connecting legs may comprise webbing or rope. The connecting legs may comprise predetermined lengths of connecting legs. The material and/or length of the connecting legs may be dependent upon the application of the device.

The harness attachment means may comprise a harness attachment member.

The portable fall protection device comprises a harness attachment member to attach the portable fall protection device to a harness and preferably to a D-ring of a harness.

Preferably the harness attachment member directly attaches the portable fall protection device to (the D-ring of) the harness.

Preferably the portable fall protection device is attached to a harness and worn on the back of a user.

Preferably the attachment member comprises a movable member and bias means wherein the bias means is arranged to bias the movable member to a closed position. The movable member may be manually movable to an open position wherein a part of a D-ring may be inserted into the attachment means and the bias means may then enable the movable member to (automatically) return to a closed position and reliably attach the portable fall protection device to a harness.

The bias means may comprise a spring and preferably comprises a redux spring.

The movable member may comprise a pin and preferably comprises a twist release pin which is retained in openings defined on the housing.

Preferably the pin is rotated through 180 degrees whilst in a pushed in position in order to enable the pin to be retracted to an open position.

The pin comprises a dual release system whereby two (simultaneous) actions are required to release the pin and to enable the pin to be (manually) retracted. The pin comprises a dual release system whereby two actuators must be (simultaneous) actuated to release the pin and to enable the pin to be (manually) retracted. The first action (actuator) may comprises a sliding movement (slidable button) and the second action comprises a push of the pin followed a (simultaneous) twist of the pin. Following this dual action dual, the pin may be (manually) retracted to an open position.

The attachment means may comprise a locking member to lock the attachment means in a closed configuration. The locking means may comprise a (slidable) button which can be secured to prevent the movement of the movable member to an open position.

The housing may comprise a chassis. The chassis may comprise a metal chassis and preferably comprises an aluminium chassis. Preferably the chassis forms part of the attachment means. The chassis may be provided on an upper part of the housing.

The chassis may provide a retaining channel and the movable member may be arranged to open and close this retaining channel to selectively retain or release a part of an attachment provided on the harness.

The chassis may comprise a first side plate and a second side plate.

Preferably the shaft of the hub comprises a plug secured therein. Preferably the plug is arranged to prevent the collapse of the shaft.

Preferably the braking member comprises a first brake pad and a second brake pad. Preferably the brake pads comprise resilient brake pads. Preferably the brake pads comprise annular brake pads.

Preferably the or each braking surface comprises an annular braking surface.

Preferably the or each engagement surface comprises an annular engagement surface.

Preferably the engagement member is movable and preferably the first engagement member and the second engagement member are movable towards each other to increase the engagement force between the braking member and the hub.

Preferably the braking member is arranged to be located within a region defined between a first engagement member and a second engagement member.

Preferably the engagement members are arranged to move towards each other through a torque setting adjustment. Preferably the torque setting adjustment member comprises a screw thread to enable the torque setting to be adjusted and (the braking force may subsequently be) locked or fixed.

Preferably portable fall protection device comprises a housing and wherein the housing comprises a resilient jacket and more preferably comprises an outer silicone jacket.

Preferably the portable fall protection device is suspended on a harness on a user's back.

According to a second aspect of the present invention there is provided a safety garment comprising a harness and a portable fall protection device, the portable fall protection device comprising:
harness attachment means to attach the portable fall protection device to the harness and for the portable fall protection device to be carried by a user;
a braking member;
an actuating member;
a rotatable hub; and
a spoolable member wound around the hub,
   wherein the hub comprises an engagement surface which is frictionally engaged with a braking surface of the braking member and wherein rotation of the hub is restrained by the friction between the engagement surface and the braking surface and, prior to use, the engagement surface is arranged to be moved relative to the braking surface by the actuating member to adjust the frictional engagement.

According to a third aspect of the present invention there is provided a method of restricting (and/or reducing a force of) a fall comprising providing a safety garment including a harness and a portable fall protection device, the portable fall protection device comprising:
harness attachment means to attach the portable fall protection device to the harness and for the portable fall protection device to be carried by a user;
a braking member;
an actuating member;
a rotatable hub; and
a spoolable member wound around the hub,
   the method comprising
frictionally engaging an engagement surface of the hub with a braking surface of the braking member and wherein rotation of the hub is restrained by the friction between the engagement surface and the braking surface; and
prior to use, operating the actuating member to move the engagement surface relative to the braking surface to adjust the frictional engagement.

### BRIEF DESCRIPTION OF THE DRAWINGS

The preferred embodiments of the present invention will now be described, by way of example only, with reference to the drawings that follow, in which:

FIG. 1 is a perspective view of a preferred embodiment of a portable fall protection device;

FIG. 2 is a front view of a preferred embodiment of a portable fall protection device;

FIG. 3 is a side view of a preferred embodiment of a portable fall protection device;

FIG. 4 is a rear view of a preferred embodiment of a portable fall protection device; and

FIG. 5 is a cross section through A-A as shown in FIG. 4.

### DESCRIPTION OF THE PREFERRED EMBODIMENTS

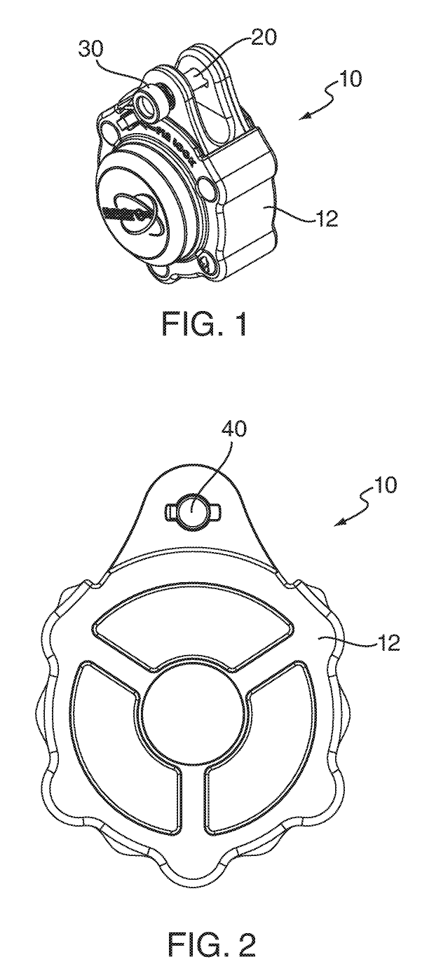

As shown in FIG. 1, a portable fall arrest device 10 (or portable fall restraint device) comprises a housing 12 with an attachment member 14 to enable the fall arrest device to be attached to a harness of a garment being worn by a user. The portable fall protection device 10 is compact and lightweight in order for the device to be mounted on a rear of a user and carried without hindrance to the user. This enables the user to continue to undertake tasks at height without carrying any large or heavy fall arrest/restraint safety devices. As previously mentioned such portable fall arrest devices or portable fall restraint devices may include lanyards with stretchable materials but such devices cannot be individually tested for safety purposes or reused. In addition, these prior art devices may comprise elongate devices which may be a hindrance when not attached to an elongate anchored safety line.

The portable fall protection device 10 essentially comprises a force reduction device. This force reduction device gradually absorbs a tensile force created within a safety line as a user falls from a height. One aim of the portable fall protection device 10 is to gradually arrest the descent of the user falling in a gradual controlled manner to prevent injury to the user (to act as a portable fall arrest device). In addition, the portable fall protection device may restrain a user to prevent the user from moving further than a predetermined position from an anchor point (to act as a portable fall restraint device). Furthermore, the portable fall protection device 10 is compact such that the portable fall protection device 10 can be constantly worn and carried on the back of the user without impinging on the tasks of the user. As a result of the structure of the portable fall protection device 10, each portable fall protection device 10 can be individually tested prior to use and can be re-used (and/or reset), if necessary after a fall. In addition, the capacity of the portable fall protection device 10 is adjustable and can be set by a manufacturer and/or operator in order to produce a bespoke device.

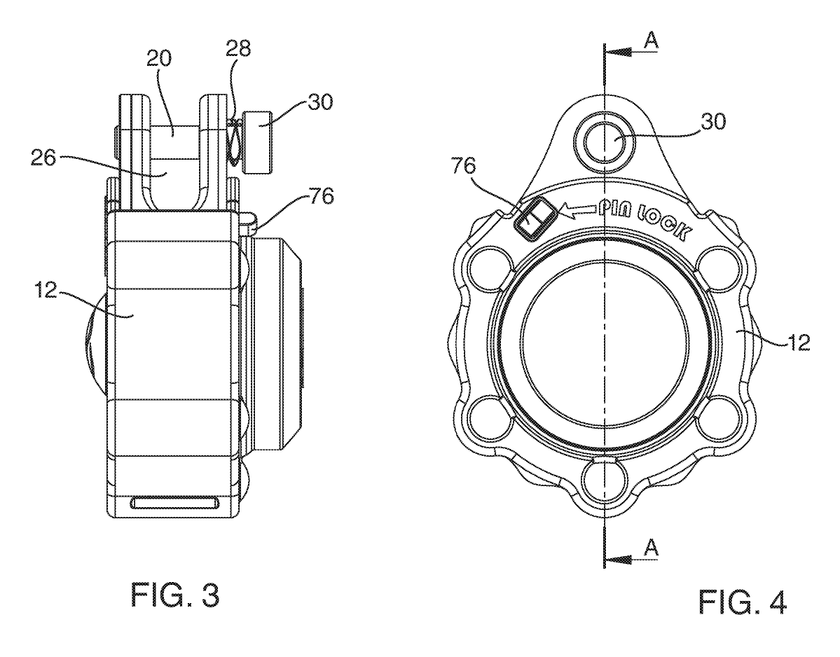

As shown in FIG. 1 to FIG. 5, the portable fall protection device 10 comprises an outer housing 12 which contains and protects the inner mechanism for the force reduction device. The protective housing 12 enables the portable fall protection device 10 to be permanently attached to and worn on the back of a user of working at height either indoors or outdoors. The protective 12 housing also protects the components and structure of the force reduction device.

The portable fall protection device 10 essentially comprises an elongate spoolable member (not shown) which is wound around a hub 16. In particular, a section or length of webbing is wound around the hub 16. One (inner) end of the section of webbing is fixed to the central shaft 18 of the hub 16. The other (outer) end of the webbing includes a connecting device to connect the webbing to a safety line (rope etc.).

The portable fall protection device 10 includes attachment means in the form of an attachment member 14 which is arranged to attach the portable fall protection device 10 directly to a harness of a user. In particular, the attachment member 14 includes a pin 20 which is arranged to engage with a D-ring provided on the safety harness of a user. Accordingly, the portable fall protection device 10 is secured in line between the harness of a user and an end of a safety line. The other end of the safety line is fixed to an anchor point and the safety line may also have a device for limiting the overall length of the safety line extending between the anchor point and the portable fall protection device 10. Alternatively, the safety line may comprise a relatively short length of rope with a fixed length.

It will be appreciated that with this overall arrangement, if a person falls then the weight of the person falling will create and produce a tensile force through the overall contiguous safety mechanism. This tensile force will tend to unspool the length of webbing which is wound around the rotatable hub 16 of the portable fall protection device 10. However, the rotatable hub 16 is engaged with a braking system such that it does not freely rotate but rotates only against a counteracting braking force. This restraint to rotation thereby creates a force reducing mechanism which is pre-set to be able to absorb and distribute the excessive tensile falling forces created by the user falling. These forces are gradually absorbed as the length of the webbing being unspooled increases and produce a cushioned fall.

As mentioned previously, since there are no components in the present invention that are sacrificed in the falling operation, the portable fall protection device 10 can be reset and thereby reused. This reset may require the portable fall protection device 10 to be returned to the manufacturer and the reset may not be simply undertaken immediately by the user due to the complexity and importance of the reset. In addition, as a result of the unique mechanisms, each individual portable fall protection device 10 can be tested prior to distribution, if required.

The specific components of the preferred embodiments of the portable fall protection device 10 will now be described, by way of example only, with specific reference to FIG. 1 to FIG. 5.

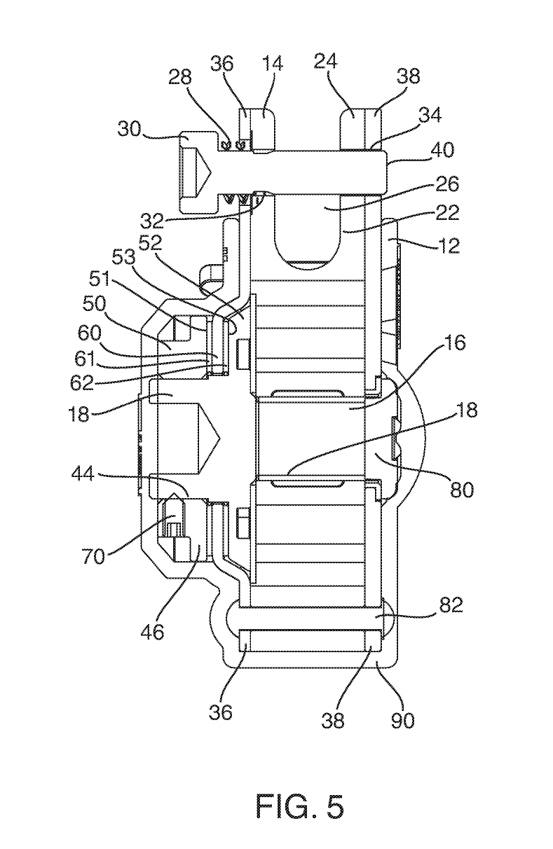

As shown in FIG. 5, the attachment means for attaching the portable fall protection device 10 directly to a D-ring of a harness comprises a pin 20. The pin 20 is arranged to extend across a channel section 22 defined in a chassis 24 of the portable fall protection device 10. The chassis 24 comprises a single piece extruded chassis defining a retaining region 26 for the D-ring. The pin 20 is retractable from a closed position (as shown in FIG. 5) to an open position (not shown).

The pin 20 is retractable against bias means when the pin 20 is moved from the closed position to the open position. In particular, the bias means comprises a spring 28 and specifically a redux spring 28 which pushes or urges the retracted pin 20 from an open position back towards the closed position. This creates a failsafe mechanism whereby the attachment means cannot be left in an inadvertent open position.

Furthermore, the pin 20 includes an initial safety release system whereby the head 30 of the pin 20 must initially be pushed inwardly against the force of the spring 28 and then subsequently twisted or turned to initially release the engagement of the pin 20 from the chassis 24. Following this initial release movement, the user must continue to grasp the head 30 of the pin 30 and to retract the pin 20 from extending across the channel section 22 which enables a part of the D-ring to be inserted into the channel 22. Once this part has been inserted, the pin 20 can be released and allowed to return to the default closed position which will now include a part of the D-ring retained within the channel 22.

The pin 20 extends across the channel 22 between openings 32, 34 provided in a first plate portion 36 and a second plate portion 38. The end 40 of the pin 20 is removable from the opening 34 in the furthest (distal) plate 38 but the pin 20 is continuously held and retained in the opening 32 of the nearside (proximal) plate 36.

As described above, the portable fall protection device 10 comprises a direct connection system or direct attachment system and the portable fall protection device 10 is attached directly to the D-ring of the harness of the user. Prior art devices use a link member (for example, a carabiner) to extend between the attachment member of the safety device and the D-ring in order to attach the device to the harness. This inevitably increases the overall length of the safety mechanism. The safety mechanism may hang further down on the back of a user and may tend to get in the way or cause an obstruction. The direct attachment mechanism of the present invention provides a simple, compact and reliably safe attachment.

The attachment means comprises a safety lock in order to lock the attachment means in a closed position/configuration. This safety lock comprises a slidable button 76 which operates an abutment stop member which prevents the pin 20 from being pushed inwardly. Accordingly, the head 30 of the pin 20 cannot be moved inwardly to commence the initial release operation until this slidable button 76 is actuated.

In use, the slidable button 76 is operated and moved to an unlocked position. The slidable button 76 may be operated against bias mechanism or urging mechanism which urges the slidable button 76 automatically back towards the default closed position. The slidable button 76 may need to be manually held in the open position and the head 30 of the pin 20 is then able to be pushed inwardly. This provides a dual release system with two individual actuators (slidable button 76 and pin 20) having to be operated simultaneously. This dual action provides a safety system to prevent inadvertent or accidental opening of the attachment means.

Once the slidable button 76 has been operated and held, the pin release system can be operated as mentioned above. In particular, in some embodiments, the head 30 of the pin 20 is pushed inwardly against the force of the spring 28. At the innermost position, the head 30 of the pin 20 is rotated through 180 degrees to release an engagement member which engages with registry means or registry opening(s)/slot(s) provided in the attachment means. Following this rotation, the pin 20 can be retracted (partially) to open the retaining channel 26. A part of the D-ring of the harness can then be directly inserted into this channel 26 in order to be retained and secured therein.

Accordingly, this provides a direct attachment mechanism without the use of any link members which would increase the length of the device 10. In addition, such link members (or intervening members) may tend to be lost or dropped and increase the complexity of the attachment system. Furthermore, these link members may provide a weak or failure spot since, for example, the intermediary/intervening member must make two separate connections which increase the chances of a problem occurring.

The housing 12 of the portable fall protection device 10 includes two chassis side plates 36, 38 which form rigid side plates. These chassis side plates 36, 38 also provide a stable structure for defining the axis of the rotatable hub 16.

The hub 16 is rotatably mounted within the housing 12 between the two side chassis plates 36, 38. The hub 16 comprises a central shaft portion 18 around which the webbing is arranged to be spooled.

The hub 16 also comprises engagement means to frictionally engage a braking surface 61, 62. The hub 16 comprises an engagement member 50, 52 which provides an engagement surface 51, 53. In the preferred embodiment shown in FIG. 5, the hub 16 comprises a first engagement member 50 providing a first engagement surface 51 and a second engagement member 52 providing a second engagement surface 53. The first engagement surface 51 and the second engagement surface 53 define a braking region directly therebetween. The portable fall protection device 10 also comprises a braking member 60 which is arranged to locate within this braking region.

The braking member 60 is a static fixed member which is formed by the first chassis side plate 36. Accordingly, the engagement surfaces 51, 53 of the hub 16 are arranged to rotate with respect to this fixed braking member 60. The opposing surfaces 51, 61, 53, 62 of the engagement members 50, 52 and the braking member 60 thereby provide a frictional (braking) force against rotation of the hub 16 and hence a force to prevent the webbing from being unspooled.

The hub 16 comprises a main shaft 18 which is rotatably mounted between the chassis side plates 36, 38. The main shaft 18 includes the second engagement member 52 which comprises a flange 52 extending outwardly from the shaft portion 18. An outer annular face 53 of this flange 52 provides the second engagement surface 53.

The main shaft 18 of the hub 16 includes a threaded end section 44 onto which an engagement component 46 is threaded. The engagement component 46 provides an inner annular face 51 which provides the first engagement face 51.

The engagement component 46 is threadably movable along the main shaft 18 towards and/or away from the braking member 60 and/or the second engagement face 53. As it will be appreciated, as the first engagement member 50 is moved towards the braking member 60 (and the second engagement member 52) the resistance to rotation for the hub 16 will be increased as the first engagement face 51 is urged towards an opposing first braking surface 61 (and the second braking surface 62 is urged towards the opposing second engagement surface 53). Conversely, as the engagement component 46 is moved away from the braking member 60 (and the second engagement member 52), the resistance to rotation of the hub 16 will decrease as the first engagement face 51 is moved away from the opposing first braking surface 61 (and the second braking surface 62 is moved away from the opposing second engagement surface 53). Overall, the two engagement members 50, 52 effectively squeeze (clamp) and compress the braking member 60 therebetween and this compressive force constrains the rotation of the engagement members 50, 52 and hence the hub/webbing to a predetermined set degree. Accordingly, the braking force can be adjusted and set. This enables the devices to be further tested and calibrated, as necessary.

The engagement component 46 comprises a locking element 70 in the form of a torque nut securing screw. This locking element 70 is used to retain the engagement component 46 in a fixed location along the threaded shaft 44 in order to set and retain the fixed frictional force.

The engagement component 46 specifically comprises a torque setting nut which is designed to be operated by the manufacturer/distributor rather than the end user. This mechanism is contained within the outer housing 12 of the portable fall protection device 10 to prevent any tampering and also to protect the mechanism.

The main shaft 18 of the hub 12 includes an end plug 80 secured at the opposite end of the shaft 18 to the engagement portions 50, 52. This end plug 80 rotatably mounts the hub 12 to the second chassis side plate 38. The plug 80 comprises an anti-collapse shaft plug which is designed to retain the integrity of the shaft whilst absorbing the falling force.

The first and second chassis side plates 36, 38 are retained in a parallel spaced configuration by securing rivets 82 extending therebetween.

The housing 12 of the portable fall protection device 10 includes an opening or slot to enable the webbing to extend therethrough. In use, the portable fall protection device 10 may hang or be suspended from the attachment means 14 on the harness on the back of the user. The safety line then extends from the connecting member of the webbing to the anchor point.

The connecting member at the end of the webbing may be connected to a single safety line and/or the connecting member at the end of the webbing may be connected to two separate safety lines. Accordingly, the portable fall protection device 10 may be incorporated into a single safety line arrangement or a dual safety line arrangement. For example, the dual system may enable one safety line to be unclipped and moved to a different anchor point as the user moves around at height.

The safety line(s) may provide or have no significant force absorbing properties. For example, the safety line(s) may comprise sections of wire rope or other lanyard arrangement. The end of the safety line(s) can effectively be seen as providing the fixed anchor point of the main structure (e.g. building).

Overall, the fall safety system may comprise a single leg (safety line) or dual legs (safety line). In the operational complete system, the device 10 is the energy absorber and the connecting leg elements become just the attachments to structure. Accordingly, the portable fall protection device 10 can be used with either one connecting leg or two connecting legs (possibly lanyards, wire rope sections etc). This leg(s) simply extends between the device and the structure (anchor point). The connecting legs may be a simple extension of the structure and do not necessarily have any energy absorbing properties.

The housing of the portable fall protection device 10 includes a silicone outer jacket 90 to further protect and conceal the operating mechanism.

The portable fall protection device 10 is designed to protect a single user and the overall weight of the device is 500 g. The portable fall protection device 10 is designed to be used with a person having a maximum weight in the region of 60 kg to 136 kg. The portable fall protection device 10 provides a settable torque, rotation driven brake to finely tune output forces depending on input loads and user weights. The present invention incorporates direct connect technology which reduces the length of the assembly and thus reducing fall distance. The quick connect end on the webbing allows for quick and easy attachment of different lanyard types to suit the specific application. The portable fall protection device 10 is directly connected to the harness.

The portable fall protection device 10 provides a force reduction device that can be torqued to a range of settings to accommodate different force outputs and different weights of users. The portable fall protection device 10 can hold at static forces of circa 50% of its ultimate “slip” range by the frictional forces (sticktion/static friction) created by the clamped brake surfaces 61, 51, 62, 53. The portable fall protection device 10 holds via a drive shaft 18 the main connecting webbing. The portable fall protection device 10 can be terminated with a range of connectors or loops this allows the user to change the device configuration. The device connecting legs can be made from all manner of materials from steel, webbing to rope and a range of lengths to suit the application. The portable fall protection device 10 is suitable for both fall arrest and fall restraint. The portable fall protection device 10 has a spring loaded side action locking barrel pin 20 that directly connects to the harness D-ring. The device 10 includes a one piece extruded aluminium chassis 24 incorporating the direct connect system. The portable fall protection device 10 includes an anti-collapse shaft end plug 80. This reduces the potential for a collapse of the shaft 18 under webbing compression.

1. A portable fall protection device comprising:
harness attachment means to attach the portable fall protection device to a harness and for the portable fall protection device to be carried by a user;
a braking member;
an actuating member;
a rotatable hub; and
a spoolable member wound around the hub,
wherein the hub comprises an engagement surface which is frictionally engaged with a braking surface of the braking member and wherein rotation of the hub is restrained by the friction between the engagement surface and the braking surface and, prior to use, the engagement surface is arranged to be moved relative to the braking surface by the actuating member to adjust the frictional engagement.

2. A portable fall protection device according to claim 1 in which the actuating member is arranged to move the engagement surface relatively towards the braking surface to increase the frictional engagement therebetween and the actuating member is arranged to move the engagement surface relatively away from the braking surface to decrease the frictional engagement therebetween.

3. A portable fall protection device according to claim 1 in which the braking member provides a first braking surface is provided on a first side of the braking member and a second braking surface is provided on a second side of the braking member.

4. A portable fall protection device according to claim 1 in which the braking member comprises a static braking surface.

5. A portable fall protection device according to claim 1 in which the hub comprises a central shaft, a first engagement member and a second engagement member and, in which, the central shaft, the first engagement member and the second engagement member are retained together in order to rotate as a single hub component.

6. A portable fall protection device according to claim 5 in which the braking member is arranged to locate between the first engagement surface and the second engagement surface.

7. A portable fall protection device according to claim 1 in which the actuating member comprises a locking device in order to lock the position of the actuating member in a predetermined set position.

8. A portable fall protection device according to claim 1 in which the spoolable member is arranged to be wound around the hub and an inner end of the spoolable member is secured to the hub and, in which, the spoolable member projects through an opening in a housing to provide an outer end with a connecting member secured thereto.

9. A portable fall protection device according to claim 1 in which the spoolable member comprises a section of webbing and the section of webbing comprises a connecting member which enables the section of webbing to be attached/detached from a safety line.

10. A portable fall protection device according to claim 1 in which the weight of the portable fall protection device is less than 1 kilogram.

11. A portable fall protection device according to claim 1 in which the harness attachment means comprise a harness attachment member and, in which, the harness attachment member directly attaches the portable fall protection device to a D-ring of the harness.

12. A portable fall protection device according to claim 11 in which the attachment member comprises a movable member and bias means wherein the bias means is arranged to bias the movable member to a closed position.

13. A portable fall protection device according to claim 12 in which the movable member comprises a twist release pin which is retained in openings defined on a housing and wherein the pin is rotated through 180 degrees whilst in a pushed in position in order to enable the pin to be retracted to an open position.

14. A portable fall protection device according to claim 1 in which the attachment means comprises a locking member to lock the attachment means in a closed configuration.

15. A portable fall protection device according to claim 1 in which the portable fall protection device comprises a housing and wherein the housing comprises a resilient jacket.

16. A portable fall protection device according to claim 1 in which the portable fall protection device is suspended on a harness on a user's back.

17. A portable fall protection device according to claim 1 in which the portable fall protection device comprises a portable fall restraint device and/or a portable fall arrest device.

18. A safety garment comprising a harness and a portable fall protection device, the portable fall protection device comprising:
harness attachment means to attach the portable fall protection device to the harness and for the portable fall protection device to be carried by a user;
a braking member;
an actuating member;
a rotatable hub; and
a spoolable member wound around the hub,
wherein the hub comprises an engagement surface which is frictionally engaged with a braking surface of the braking member and wherein rotation of the hub is restrained by the friction between the engagement surface and the braking surface and, prior to use, the engagement surface is arranged to be moved relative to the braking surface by the actuating member to adjust the frictional engagement.

19. A method of restricting a fall comprising providing a safety garment including a harness and a portable fall protection device, the portable fall protection device comprising:
harness attachment means to attach the portable fall protection device to the harness and for the portable fall protection device to be carried by a user;
a braking member;
an actuating member;
a rotatable hub; and
a spoolable member wound around the hub,
the method comprising
frictionally engaging an engagement surface of the hub with a braking surface of the braking member and wherein rotation of the hub is restrained by the friction between the engagement surface and the braking surface; and
prior to use, operating the actuating member to move the engagement surface relative to the braking surface to adjust the frictional engagement.

20-22. (canceled)
